(19) United States
(12) Patent Application Publication
(10) Pub. No.: US 2024/0122400 A1
(43) Pub. Date: Apr. 18, 2024

(54) LIQUID FLOW VELOCITY CONTROL METHOD AND BEVERAGE MAKER USING THE SAME

(71) Applicant: OTFES CO., LTD., Taoyuan City (TW)

(72) Inventor: Chih-Te LIN, Taoyuan City (TW)

(73) Assignee: OTFES CO., LTD., Taoyuan City (TW)

(21) Appl. No.: 18/395,397

(22) Filed: Dec. 22, 2023

Related U.S. Application Data
(62) Division of application No. 17/234,994, filed on Apr. 20, 2021.

(30) Foreign Application Priority Data
May 26, 2020 (TW) 109117515

(51) Int. Cl. A47J 31/52; A47J 31/46

(52) U.S. Cl. CPC A47J 31/5255; A47J 31/461; A47J 31/5253

(57) ABSTRACT

A beverage maker has pulse-width modulation (PWM) signals and preset flow velocity values stored therein and supplies a liquid through a flow velocity control method, which includes setting a target flow velocity value; setting one of the preset flow velocity values matching the target flow velocity value as a matched flow velocity value and setting one of the PWM signals corresponding to the matched flow velocity value as an executing PWM signal; supplying the liquid according to the executing PWM signal and sensing an actual liquid flow velocity; performing an algorithm on the executing PWM signal and a sensed liquid temperature and dispensing time to generate an adjusted PWM signal when a difference exists between the actual and the target flow velocity value; and finally, changing the liquid flow velocity according to the adjusted PWM signal, so that the beverage maker supplies the liquid at the target flow velocity stably.

### FIELD OF THE INVENTION

The present invention relates to a liquid flow velocity control method, and more particularly, to a liquid flow velocity control method that can increase or decrease a flowing velocity of a liquid being dispensed by a beverage maker according to a flow velocity, a temperature and a dispensing time of the liquid. The present invention also relates to a beverage maker using the liquid flow velocity control method.

### BACKGROUND OF THE INVENTION

The world's cuisine culture is changing, diversified food ingredients are available, and a variety of ways for cooking food has been developed. To provide diversified liquid drinks in a convenient manner, many specific systems and methods for this purpose have also been developed.

Currently, specialty beverage stores are common in the market to prepare customized beverages for customers according to their preference in beverage temperature or sweetness, for example. However, in these beverage stores, the beverages are prepared manually, and the taste of the prepared beverages often changes with the beverage brewing operators' experience. And, the taste of the same type of beverage prepared even by the same brewing operator but at different times might not be consistent owing to different flow velocities of the liquid used to brew. Therefore, it is very possible the beverages brewed from the same type of beverage brewing materials are not consistent in taste, no matter the beverages are brewed by inexperienced or experienced brewing operators.

### SUMMARY OF THE INVENTION

A primary object of the present invention is to develop a method for controlling the flow velocity of a liquid dispensed from a beverage maker, so that different brewing operators can always brew the same type of beverage brewing material using the same liquid flow velocity to reproduce consistent taste of the beverage.

Another object of the present invention is to develop a liquid flow velocity control method by providing a different arrangement relation among a liquid supply unit, a flow meter and a control valve in a beverage maker, so that heated liquid does not produce bubbles at a high temperature when it is supplied from the liquid supply unit to the flow meter, allowing the flow meter to sense the liquid flow velocity accurately.

To achieve the above and other objects, the liquid flow velocity control method according to the present invention is designed for implementation on a beverage maker, which has a plurality of pulse-width modulation (PWM) signals and a plurality of preset flow velocity values stored therein. The PWM signals are in one-to-one correspondence to the preset flow velocity values. The liquid flow velocity control method includes a setting step, a matching step, a liquid supplying step, a flow velocity checking step, a compensating step and a liquid supply adjusting step.

In the setting step, a target flow velocity value is set for the beverage maker. In the matching step, one of the preset flow velocity values matching the target flow velocity value is set as a matched flow velocity value, and one of the PWM signals corresponding to the matched flow velocity value is set as an executing PWM signal.

In the liquid supplying step, the executing PWM signal is used to adjust a valve opening of the beverage maker, so that a liquid supplied flows at a velocity, which provides an actual flow velocity value. In the flow velocity checking step, the actual flow velocity value is compared with the target flow velocity value, and a compensation instruction is generated to the beverage maker when a difference between the actual flow velocity value and the target flow velocity value does not satisfy a tolerance value. In the compensating step, the beverage maker follows the compensation instruction to sense a temperature of the liquid and a dispensing time of the liquid, and performs an algorithm on the executing PWM signal, the liquid temperature and the liquid dispensing time to generate an adjusted PWM signal. In the liquid supply adjusting step, the valve opening of the beverage maker is changed according to the adjusted PWM signal to increase or decrease the flow velocity of the liquid and the actual flow velocity value is changed to an adjusted flow velocity value accordingly, so that a difference between the adjusted flow velocity value and the target flow velocity value satisfies the tolerance value.

According to the above embodiment, in the flow velocity checking step, when the difference between the actual flow velocity value and the current preset flow velocity value satisfies the tolerance value, a flow measuring instruction is generated and a flow checking step and a liquid supply ending step are further performed in the liquid flow velocity control method.

In the flow checking step, a total flow of the liquid is sensed according to the flow measuring instruction to generate an actual value of flow, and the beverage maker generates a stop instruction when the actual value of flow is the same as a preset value of flow. In the liquid supply ending step, the valve opening of the beverage maker is closed to stop supplying the liquid according to the stop instruction generated by the beverage maker. According to a preferred embodiment of the present invention, in the flow checking step, when the actual flow velocity value is different from the preset flow velocity value, the flow velocity checking step is repeated.

In the compensating step, the beverage maker will receive a first compensation parameter and a second compensation parameter according to the temperature of the supplied liquid and the dispensing time of the liquid; and the adjusted PWM signal is generated by performing the algorithm on the executing PWM signal and the first and the second compensation parameters. Further, in the compensating step, when the actual flow velocity value is larger than the target flow velocity value, a first algorithm is selected for performing an operation on the executing PWM signal, the first compensation parameter and the second compensation parameter to generate the adjusted PWM signal; and on the other hand, when the actual flow velocity value is smaller than the target flow velocity value, a second algorithm that is different with the first algorithm is selected for performing another operation on the executing PWM signal, the first compensation parameter and the second compensation parameter to generate the adjusted PWM signal.

The beverage maker according to the present invention mainly includes a liquid supply unit, a storage unit, an input unit, a processing unit, a control valve, and a sensor unit. According to an embodiment, the liquid supply unit is used to supply a liquid; and the storage unit has stored therein a plurality of PWM signals and a plurality of preset flow velocity values for indicating different flow velocities of the liquid. Wherein, the PWM signals are in one-to-one correspondence to the preset flow velocity values.

At the input unit, a target flow velocity value is input to indicate a flow velocity of the liquid that is to be reached. The processing unit is electrically connected to the storage unit and the input unit and is capable of setting one of the preset flow velocity values that matches the target flow velocity value as a matched flow velocity value and setting one of the PWM signals that is corresponding to the matched flow velocity value as an executing PWM signal.

Further, the control valve is used to receive the executing PWM signal from the processing unit and adjust a valve opening thereof according to the executing PWM signal. The sensor unit is used to sense a flow velocity, a temperature and a dispensing time of the liquid supplied from the liquid supply unit to provide an actual flow velocity value indicating an actual flow velocity of the liquid, an actual temperature value indicating a current temperature of the liquid, and an actual dispensing time value indicating a time period by which the liquid has been supplied from the liquid supply unit.

Wherein, when the processing unit determines a difference between the actual flow velocity value and the target flow velocity value does not satisfy a tolerance value, the processing unit generates a compensation instruction and performs an algorithm on the executing PWM signal, the temperature of the liquid and the dispensing time of the liquid according to the compensation instruction to generate an adjusted PWM signal, and the control valve adjusts the valve opening thereof according to the adjusted PWM signal, so that the flow velocity of the liquid is increased or decreased to change the actual flow velocity value to an adjusted flow velocity value and accordingly, make a difference between the adjusted flow velocity value and the target flow velocity value satisfies the tolerance value.

According to the above embodiment, the beverage maker further includes a scratchpad unit electrically connected to the processing unit for storing the executing PWM signal therein. When the beverage maker stops operating, the scratchpad unit will delete the executing PWM signal. According to the present invention, the adjusted PWM signal can be written into and stored in the scratchpad unit, and the scratchpad unit will also delete the executing PWM signal when the adjusted PWM signal is stored in the scratchpad unit, so that there is always only one PWM signal stored in the scratchpad unit.

In the present invention, the sensor unit further includes a flow meter for sensing a flow velocity of the liquid, and the flow meter is arranged between the liquid supply unit and the control valve.

The present invention is characterized in that, when the processing unit detects the difference between the actual flow velocity value and the matched flow velocity value does not satisfy the tolerance value, it will perform an algorithm on the executing PWM signal, the current liquid temperature and the dispensing time of the liquid supplied from the liquid supply unit to generate the adjusted PWM signal and transfers the latter to the control valve for the same to change its valve opening according to the adjusted PWM signal, so that the flow velocity of the liquid is increased or decreased to change the actual flow velocity value to the adjusted flow velocity value, allowing a difference between the adjusted flow velocity value and the target flow velocity value to satisfy the tolerance value. With these arrangements, the same type of beverage brewing material can always be brewed using a liquid of the same flow velocity to present a consistent taste even if the beverage brewing material is brewed by different brewing operators.

In addition, in the present invention, the flow meter of the sensor unit is arranged between the liquid supply unit and the control valve. With this arrangement, the flow meter is located closer to the liquid supply unit, and the heated liquid supplied from the liquid supply unit and having a high temperature can flow to and through the flow meter within a shortened time without producing bubbles in the course of flowing to the flow meter, so that the flow meter can sense the liquid flow velocity accurately.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps included in a liquid flow velocity control method according to a preferred embodiment of the present invention;

FIG. 2 is a structural block diagram of a beverage maker according to a preferred embodiment of the present invention;

FIG. 3 is a block diagram showing how a setting step and a matching step of the liquid flow velocity control method in FIG. 1 are performed on the beverage maker of the present invention;

FIG. 4 is a block diagram showing how a liquid supplying step of the liquid flow velocity control method in FIG. 1 is performed on the beverage maker of the present invention;

FIG. 5 is a block diagram showing how a flow velocity checking step of the liquid flow velocity control method in FIG. 1 is performed on the beverage maker of the present invention;

FIG. 6 is a block diagram showing how a compensating step of the liquid flow velocity control method in FIG. 1 is performed on the beverage maker of the present invention;

FIG. 7 is a block diagram showing how a liquid supply adjusting step of the liquid flow velocity control method in FIG. 1 is performed on the beverage maker of the present invention;

FIG. 8 is a block diagram showing how the flow velocity checking step is performed again on the beverage maker of the present invention;

FIG. 9 is a block diagram showing how a flow checking step of the liquid flow velocity control method in FIG. 1 is performed on the beverage maker of the present invention; and

FIG. 10 is a block diagram showing how a liquid supply ending step of the liquid flow velocity control method in FIG. 1 is performed on the beverage maker of the present invention;

### DETAILED DESCRIPTION OF THE PREFERRED EMBODIMENTS

The present invention will now be described with some preferred embodiments thereof and by referring to the accompanying drawings.

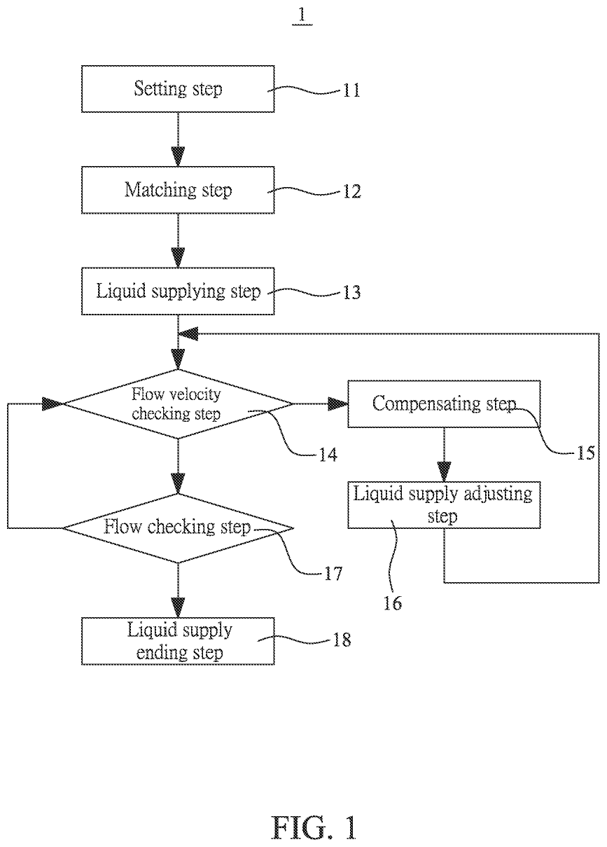

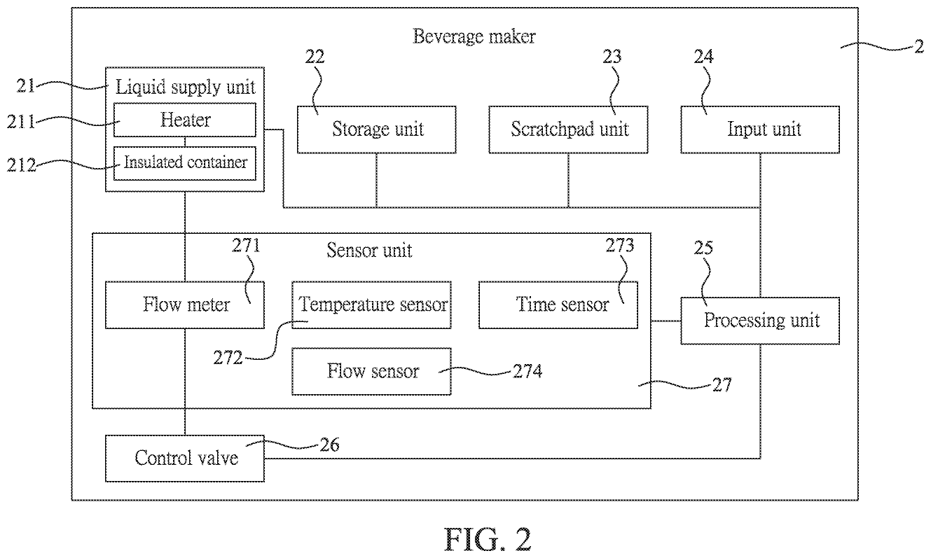

Please refer to FIGS. 1 and 2. The present invention relates to a liquid flow velocity control method 1 for implementing on a beverage maker 2. In a preferred embodiment of the present invention, the beverage maker 2 includes a liquid supply unit 21, a storage unit 22, a scratchpad unit 23, an input unit 24, a processing unit 25, a control valve 26, and a sensor unit 27. The liquid supply unit 21 supplies a liquid, and includes a heater 211 and an insulated container 212. The heater 211 heats the liquid supplied to a desired temperature, and the heated liquid flows into the insulated container 212 for storing and keeping warm. The storage unit 22 stores therein a plurality of pulse-width modulation (PWM) signals, a plurality of preset flow velocity values, three first compensation parameters, two second compensation parameters, two algorithms, a tolerance value and a preset value of flow. The PWM signals are different in their contents, and the PWM signals are in one-to-one correspondence to the preset flow velocity values. Each of the preset flow velocity values indicates a flow velocity of the liquid to be reached at the time the liquid is dispensed from the beverage maker 2. And, the preset flow velocity values are different from one another.

In the preferred embodiment, the three first compensation parameters are values different from one another and they are in one-to-one correspondence to a plurality of preset temperature values that indicate a liquid temperature of the heated liquid. In the illustrated preferred embodiment, one of the first compensation parameters is a value of 5, another one of the first compensation parameters is a value of 7, and the last one of the first compensation parameters is a value of 10. The first compensation parameter in the value of 5 is used in the case the liquid temperature is lower than 79° C., the first compensation parameter in the value of 7 is used in the case the liquid temperature is ranged from 80° C. to 90° C., and the first compensation parameter in the value of 10 is used in the case the liquid temperature is higher than 91° C.

Further, the two second compensation parameter are values different from each other, and they are in one-to-one correspondence to a plurality of preset dispensing time values for the heated liquid supplied by the liquid supply unit 21. In the illustrated preferred embodiment, the two second compensation parameters are respectively 0 and 1 in value. The second compensation parameter in the value of 0 is suitable for use in the case the dispensing time of the liquid supplied by the liquid supply unit 21 is less than 10 seconds, and the other second compensation parameter in the value of 1 is suitable for use in the case the dispensing time of the liquid supplied by the liquid supply unit 21 is longer than 11 seconds.

The two algorithms have different operation formulas. In the illustrated preferred embodiment, the operation formula for one of the two algorithms is A+(B+C). The algorithm using the operation formula A+(B+C) is defined as a first algorithm, which is applied to a state in which an actual flow velocity value of the liquid is smaller than a target flow velocity value to be reached by the liquid. On the other hand, the operation formula for the other algorithm is A−(B+2C). The algorithm using the operation formula A−(B+2C) is defined as a second algorithm, which is applied to a state in which the actual flow velocity value is larger than the target flow velocity value. Further, the tolerance value indicates a difference between the actual flow velocity value and the target flow velocity value that is within an acceptable range, and the preset value of flow indicates a total flow of the liquid that has to be reached.

As shown in FIG. 2, the scratchpad unit 23 is used to store information and the input unit 24 is used to generate information. The processing unit 25 is electrically connected to the storage unit 22, the scratchpad unit 23, the input unit 24 and the control valve 26. The control valve 26 can control the flow velocity of the liquid. The sensor unit 27 includes a flow meter 271, a temperature sensor 272, a time sensor 273 and a flow sensor 274. In the illustrated preferred embodiment, the flow meter 271 is used to sense a flow velocity of the liquid and is located between the insulated container 212 of the liquid supply unit 21 and the control valve 26 and electrically connected to the processing unit 25. The temperature sensor 272 is used to sense a temperature of the liquid and electrically connected to the processing unit 25. The time sensor 273 is used to sense a dispensing time of the liquid supplied by the liquid supply unit 21, and the flow sensor 274 is electrically connected to the processing unit 25 and used to sense a total flow of the liquid.

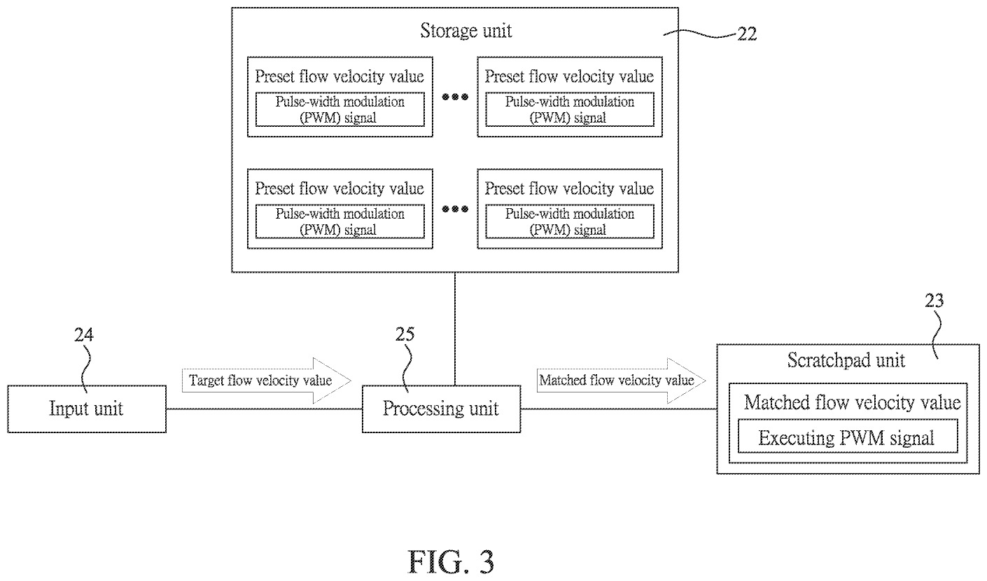

Please refer to FIGS. 1 and 3. In practical implementation of the present invention, a user first performs a setting step 11 to input the target flow velocity value at the input unit 24. The input target flow velocity value is transferred from the input unit 24 to the processing unit 25, at where the preset flow velocity values are compared with the target flow velocity value, so that one of the preset flow velocity values that matches the target flow velocity value is selected and defined as a matched flow velocity value. Meanwhile, one of the PWM signals that is corresponding to the matched flow velocity value is defined as an executing PWM signal. Then, the processing unit 25 copies the matched flow velocity value and the executing PWM signal to the scratchpad unit 23, so that the matched flow velocity value and the executing PWM signal are stored in the scratchpad unit 23 to complete a matching step 12.

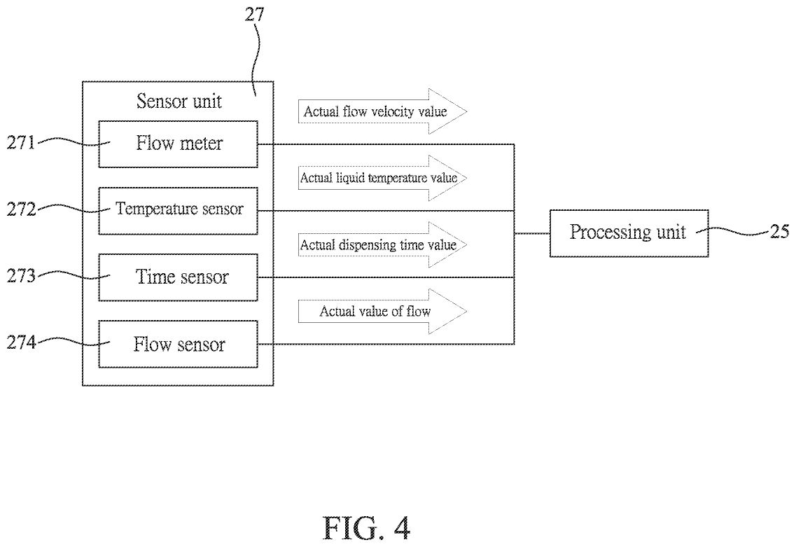

Please refer to FIGS. 1 and 4. After the matching step 12, a liquid supplying step 13 is performed. In the liquid supplying step 13, the processing unit 25 transfers the executing PWM signal from the scratchpad unit 23 to the control valve 26 for controlling the control valve 26 to a valve opening according to the executing PWM signal and allowing the heated liquid to flow out of the insulated container 212 of the liquid supply unit 21. The heated liquid flowed out of the insulated container 212 first passes through the flow meter 271 of the sensor unit 27 before it flows through the control valve 26. Wherein, when the heated liquid flows out of the insulated container 212, the flow meter 271 of the sensor unit 27 senses per unit time an actual flow velocity of the liquid to provide the actual flow velocity value, and meanwhile, the temperature sensor 272 of the sensor unit 27 also senses per unit time an actual temperature of the liquid at present time to provide an actual liquid temperature value that indicates the current temperature of the liquid. Further, the time sensor 273 of the sensor unit 27 senses per unit time a time period that the liquid has flowed till now to provide an actual dispensing time value that indicates the time period that the liquid has been dispensed till now, and the flow sensor 274 of the sensor unit 27 also senses s total flow of the liquid that has flowed out of the insulated container 212 to provide an actual value of flow that indicates the total flow of the liquid. When the flow meter 271, the temperature sensor 272 and the time sensor 273 have respectively provided the actual flow velocity value, the actual liquid temperature value and the actual dispensing time value, these actual values are transferred by the sensor unit 27 to the processing unit 25. In the illustrated preferred embodiment, since the flow meter 271, the temperature sensor 272 and the time sensor 273 respectively sense the liquid per unit time, a plurality of the above-mentioned actual flow velocity values, actual liquid temperature values and actual dispensing time values will be provided. Therefore, the processing unit 25 will receive a plurality of actual flow velocity values, actual liquid temperature values and actual dispensing time values.

In the present invention, the flow meter 271 of the sensor unit 27 is arranged between the liquid supply unit 21 and the control valve 26 to be located closer to the liquid supply unit 21. Therefore, the heated liquid, supplied from the liquid supply unit 21, in a higher temperature can flow to the flow meter 271 within a shortened time period without forming bubbles due to the high temperature thereof, so the flow meter 271 senses the flow velocity of the liquid more accurately and provide the actual flow velocity value that reflects correct information.

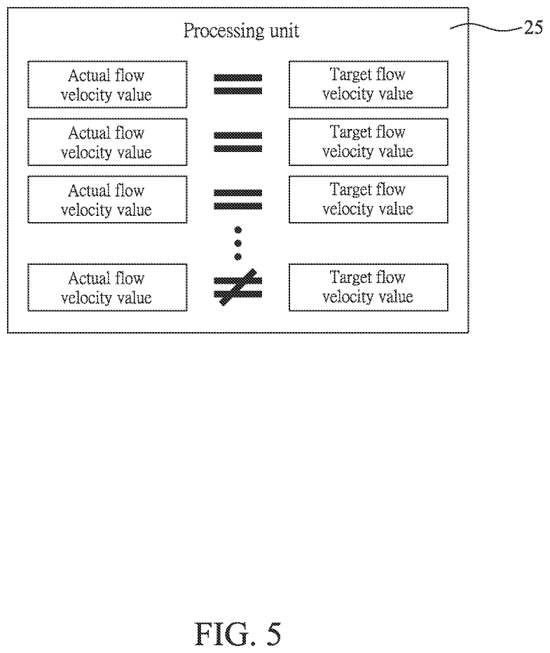

Please refer to FIGS. 1 and 5. After the liquid supplying step 13, a flow velocity checking step 14 is performed. As mentioned above, in the liquid supplying step 13, the flow meter 271 of the sensor unit 27 senses per unit time the actual flow velocity of the liquid to provide a plurality of actual flow velocity values, and the actual flow velocity values are transferred to the processing unit 25. In the flow velocity checking step 14, the processing unit 25 determines whether the differences between the individual actual flow velocity values and the target flow velocity value satisfy the tolerance value.

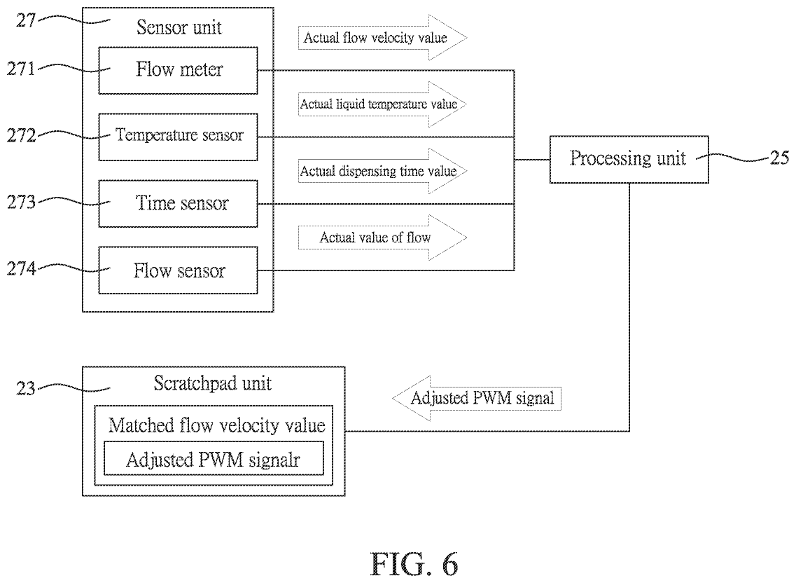

Please refer to FIGS. 1 and 6. In the event the processing unit 25 finds the difference between the actual flow velocity value in a certain unit time and the target flow velocity value does not satisfy the tolerance value, a compensation instruction is generated by the processing unit 25 to start a compensating step 15. In the compensating step 15, the processing unit 25 retrieves the actual flow velocity value, the actual liquid temperature value and the actual dispensing time value in that unit time according to the compensation instruction, and further retrieve one of the compensation parameters, one of the second compensation parameters and one of the algorithms from the storage unit 22 according to the actual flow velocity value, the actual liquid temperature value and the actual dispensing time value at that time. Then, the processing unit 25 performs the selected algorithm on the executing PWM signal, the selected first compensation parameter and the selected second compensation parameter to derive an adjusted PWM signal that has a numeral value different from that of the executing PWM signal. The adjusted PWM signal is transferred to, written into and stored in the scratchpad unit 23. When the scratchpad unit 23 stores the adjusted PWM signal, it also deletes the executing PWM signal at the same time. Therefore, there is only one PWM signal stored in the scratchpad unit 23.

In the illustrated preferred embodiment, if the processing unit 25 finds a difference between the actual flow velocity value and the matched flow velocity value in the fourth second of the dispensing time does not satisfy the tolerance value, and the actual liquid temperature value read by the processing unit 25 in the fourth second of dispensing time is 85° C., which falls between 80° C. and 90° C., the processing unit 25 will retrieve the first compensation parameter that has a value of 7. Then, the processing unit 25 will also read that the actual dispensing time value in the fourth second is 4, which is less than 10 seconds, so that the processing unit 25 retrieves the second compensation parameter that has a value of 0. Thereafter, the processing unit 25 will read that the actual flow velocity value in the fourth second is cubic centimeter per second (cc/sec), which is smaller than the target flow velocity of 25 cc/sec. Thus, the processing unit 25 retrieves the first algorithm having the operation formula A+(B+C). Afterwards, the processing unit 25 substitutes the executing PWM signal, the first compensation parameter and the second compensation parameter for A, B and C in the operation formula A+(B+C) sequentially, so as to do arithmetic operation on the executing PWM signal, the first compensation parameter and the second compensation parameter according to the first compensation parameter to derive the adjusted PWM signal. Wherein, when the actual flow velocity value is larger than the target flow velocity value, the processing unit 25 will retrieve the second algorithm that uses the operation formula of A−(B+2C).

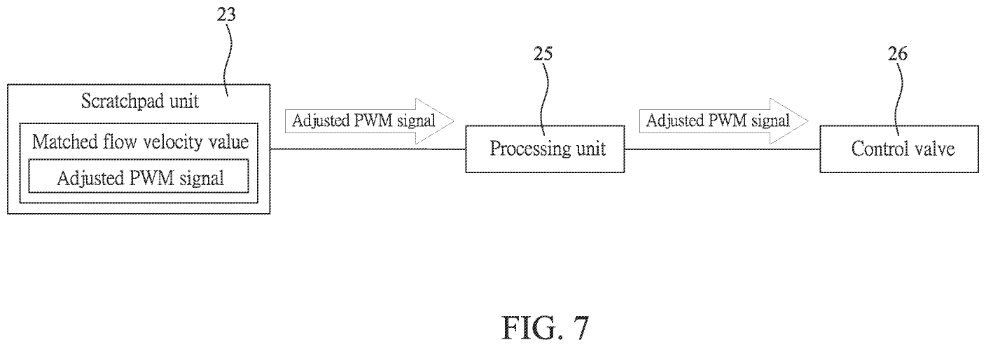

Please refer to FIGS. 1 and 7. After the compensating step 15, a liquid supply adjusting step 16 is performed. In the liquid supply adjusting step 16, the processing unit 25 transfers the adjusted PWM signal stored in the scratchpad unit 23 to the control valve 26, so as to control the control valve 26 to change the valve opening according to the adjusted PWM signal and increase the flow velocity of the heated liquid flowing out from the insulated container 212 of the liquid supply unit 21. After the liquid supply adjusting step 16, the flow velocity checking step 14 is performed again. In the event it is found the liquid flow velocity has been increased, the flow meter 271 of the sensor unit 27 sensing the liquid with the increased flow velocity will detect the newest flow velocity of the liquid to provide an adjusted flow velocity value that is larger than the actual flow velocity value. Meanwhile, the temperature sensor 272 of the sensor unit 27 will also sense the liquid with the increased flow velocity and detect a newest temperature of the liquid to provide an adjusted liquid temperature value, and the time sensor 273 of the sensor unit 27 will sense the liquid with the increased flow velocity and detect a newest dispensing time of the liquid supplied by the liquid supply unit 21 to provide an adjusted dispensing time value.

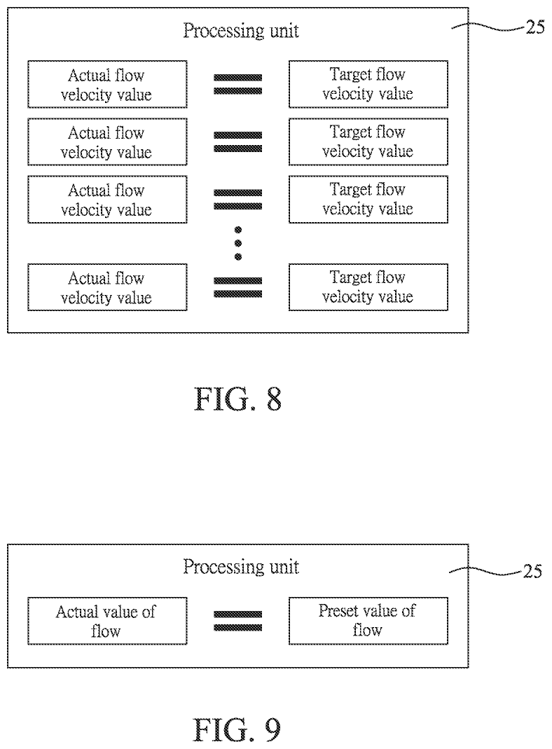

Please refer to FIGS. 1 and 8. When the flow velocity checking step 14 is performed again and the flow meter 271 of the sensor unit 27 generates the adjusted flow velocity value, the adjusted flow velocity value is transferred by the flow meter 271 to the processing unit 25. On receipt of the newest adjusted flow velocity value, the processing unit 25 determines whether a difference between the adjusted flow velocity value and the target flow velocity value satisfies the tolerance value. In the case the difference between the adjusted flow velocity value and the matched flow velocity does not satisfy the tolerance value, the compensating step 15 and the liquid supply adjusting step 16 are repeated. On the other hand, in the case the difference between the adjusted flow velocity value and the target flow velocity value satisfies the tolerance value, the processing unit 25 generates a flow measuring instruction to perform a flow checking step 17, as shown in FIG. 9.

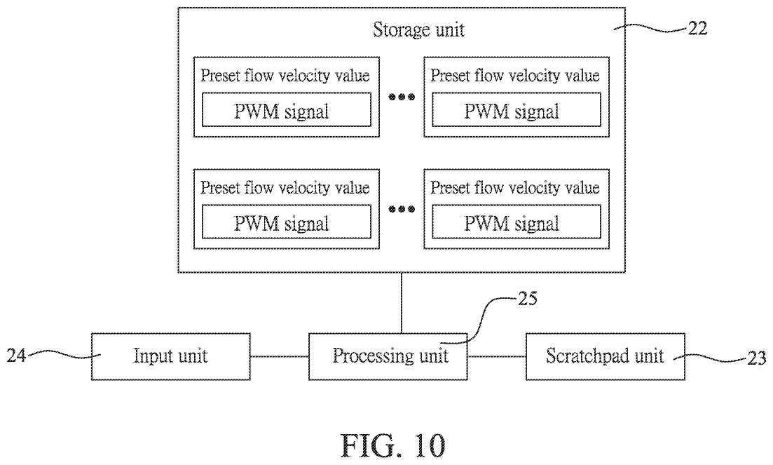

Please refer to FIGS. 1 and 9. In performing the flow checking step 17, the processing unit 25 compares the actual value of flow with the preset value of flow according to the flow measuring instruction and determines whether the actual value of flow is the same as the preset value of flow. In the case the processing unit 25 determines the actual value of flow is not the same as the preset value of flow, the flow velocity checking step 14 is performed again because there might be a change in the flow of the liquid supplied from the liquid supply unit 21. On the other hand, in the case the processing unit 25 determines the actual value of flow is the same as the preset value of flow, the processing unit 25 generates a stop instruction and starts performing a liquid supply ending step 18. Please refer to FIGS. 1 and 10. In performing the liquid supply ending step 18, the processing unit 25 transfers the stop instruction to the control valve 26, so that the control valve 26 is closed according to the stop instruction and the liquid is no longer dispensed from the insulated container 212 of the liquid supply unit 21. Finally, the beverage maker 2 stops operating and the adjusted PWM signal and the matched flow velocity value are deleted from the scratchpad unit 23.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A beverage maker, comprising:
a liquid supply unit for supplying a liquid;
a storage unit having stored therein a plurality of PWM signals and a plurality of preset flow velocity values for indicating different flow velocities of the liquid; and the PWM signals being in one-to-one correspondence to the preset flow velocity values;
an input unit, at which a target flow velocity value is input to indicate a flow velocity of the liquid that is to be reached;
a processing unit being electrically connected to the storage unit and the input unit and being capable of setting one of the preset flow velocity values that matches the target flow velocity value as a matched flow velocity value and setting one of the PWM signals that is corresponding to the matched flow velocity value as an executing PWM signal;
a control valve for receiving the executing PWM signal from the processing unit and adjusting a valve opening thereof according to the executing PWM signal; and
a sensor unit for sensing a flow velocity, a temperature and a dispensing time of the liquid supplied from the liquid supply unit to provide an actual flow velocity value indicating an actual flow velocity of the liquid, an actual temperature value indicating a current temperature of the liquid, and an actual dispensing time value indicating a time period by which the liquid has been supplied from the liquid supply unit; and
wherein, when the processing unit determines a difference between the actual flow velocity value and the target flow velocity value does not satisfy a tolerance value, the processing unit generates a compensation instruction and performs an algorithm on the executing PWM signal, the temperature of the liquid and the dispensing time of the liquid according to the compensation instruction to generate an adjusted PWM signal, and the control valve adjusts the valve opening thereof according to the adjusted PWM signal, so that the flow velocity of the liquid is increased or decreased to change the actual flow velocity value to an adjusted flow velocity value and accordingly, make a difference between the adjusted flow velocity value and the target flow velocity value satisfies the tolerance value.

2. The beverage maker as claimed in claim 1, further comprising a scratchpad unit electrically connected to the processing unit for storing the executing PWM signal therein, and the scratchpad unit deleting the executing PWM signal therefrom when the beverage maker stops operating.

3. The beverage maker as claimed in claim 2, wherein the adjusted PWM signal can be written into and stored in the scratchpad unit, and the scratchpad unit will also delete the executing PWM signal when the adjusted PWM signal is stored in the scratchpad unit, so that there is always only one PWM signal stored in the scratchpad unit.

4. The beverage maker as claimed in claim 1, wherein the sensor unit further includes a flow meter for sensing a flow velocity of the liquid and is arranged between the liquid supply unit and the control valve.
